(19) United States
(12) Patent Application Publication
(10) Pub. No.: US 2011/0010363 A1
(43) Pub. Date: Jan. 13, 2011

(54) INFORMATION PROCESSING APPARATUS, INFORMATION PROCESSING METHOD, AND PROGRAM

(75) Inventors: Shunichi Homma, Tokyo (JP); Yoshiaki Iwai, Tokyo (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/825,996

(22) Filed: Jun. 29, 2010

(30) Foreign Application Priority Data
Jul. 8, 2009 (JP) 2009-161970

(51) Int. Cl. G06F 17/30

(52) U.S. Cl. 707/723; 707/769; 707/E17.03

(57) ABSTRACT

There is provided an information processing apparatus including a storage section for storing a plurality of images and a plurality of related terms related to each of the plurality of images, the plurality of images being associated with the plurality of related terms, an input section for inputting a concept term indicating a predetermined concept, an extraction section for extracting, when the input concept term corresponds to the related term, the plurality of images each associated with the related term, a selection section for selecting an image which matches the concept of the concept term from the extracted plurality of images, a collection section for collecting a related term associated with the selected image which matches the concept of the concept term, and a calculation section for calculating a term feature amount of a term group of the collected related term.

### BACKGROUND OF THE INVENTION

1. Field of the Invention

The present invention relates to an information processing apparatus, an information processing method, and a program, and more particularly relates to an information processing apparatus, an information processing method, and a program for creating/controlling a profile of a user.

2. Description of the Related Art

In recent years, a profile of each user has been created based on a search history or a purchase history of the user, and there has been performed a search of a commercial product or a recommendation of content utilizing the profile. In creating the profile, there are used an attribute of the user which is prepared beforehand based on the kind and the manufacturer of the commercial product that the user purchases, a keyword input by the user, and the like. For example, the keyword input by the user and the attribute of the user prepared beforehand are matched with each other, and a commercial product or content related to the input keyword is recommended.

However, in the method described above, there are many cases where the keyword input by the user and a keyword or the attribute prepared beforehand are not matched with each other. That is, even when the user inputs a keyword while having some kind of concept in his/her mind, there are some cases where very few of those having the concept exist or some cases where those having different concept from the user's concept are obtained. Further, when the user had difficulties in verbalizing the concept which the user imagines, there was an issue that the creation itself of a query to be a search key was difficult to perform.

Consequently, there is disclosed a technology for creating a profile of each user based on a search query term and a search history using the search query term and providing a search result desired by the user (for example, Japanese Patent Application Laid-Open No. 2008-507041).

### SUMMARY OF THE INVENTION

However, in Japanese Patent Application Laid-Open No. 2008-507041, it is possible to extract preference with respect to a specific object name or proper noun, but there is a possibility that information that is far from the concept of the user is provided in the case of emotional expression including adjective, the interpretation of which differs between individuals.

In light of the foregoing, it is desirable to provide a novel and improved information processing apparatus, information processing method, and program, which are capable of creating a user profile based on an image group classified with respect to each concept that the user imagines.

According to an embodiment of the present invention, there is provided an information processing apparatus, in which a plurality of images are associated with a plurality of related terms related to each of the plurality of images, which includes an input section for inputting a concept term indicating a predetermined concept, an extraction section for extracting, when the concept term input by the input section corresponds to the related term, the plurality of images each associated with the related term, a selection section for selecting an image which matches the concept of the concept term from the plurality of images extracted by the extraction section, a collection section for collecting a related term associated with the image which matches the concept of the concept term and which is selected by the selection section, and a calculation section for calculating a term feature amount of a term group of the related term collected by the collection section.

According to the above configuration, when the concept term indicating the predetermined concept is input by operation of the user or the like and in the case where the concept term and the related term which is related to the plurality of images stored in the storage section correspond to each other, the plurality of images associated with the related term are extracted from the storage section. Then, in accordance with the operation of the user, an image which matches the concept of the concept term is selected from the extracted plurality of images. The related term associated with the image which matches the concept of the selected concept term is collected, and the term feature amount of the term group of the collected related term is calculated. Thus, a user profile can be created based on an image group classified with respect to each concept that the user imagines.

Further, the selection section may select an image which matches the concept of the concept term from the plurality of images extracted by the extraction section in accordance with operation of a user. Further, the calculation section may calculate a term feature amount depending on an appearance frequency of the related term collected by the collection section. Still further, the calculation section may calculate a term feature amount depending on an appearance frequency of a related term associated with an image group of images that are selected as images which do not match the concept term by the selection section.

The information processing apparatus may further include a creation section for creating an image recognizer capable of recognizing a predetermined image feature amount from an image group which matches the concept of the concept term and which is selected by the selection section. In addition, the information processing apparatus may further include a recording section for recording the concept term which is correlated with the term feature amount calculated by the calculation section into a storage medium as concept information.

Further, the recording section may record the concept term by mapping the concept term on a predetermined concept map depending on the term feature amount. Further, the recording section may record the concept term, which is correlated with the related image group which includes the image selected by the selection section, the related term group which includes the related term and which is collected by the collection section, and the term feature amount which is calculated by the calculation section, into the storage medium as concept information.

Further, when, in addition to the plurality of images, other plurality of images are newly associated with a plurality of related terms related to each of the other plurality of images, the extraction section may extract the plurality of images each associated with the related term corresponding to the concept term, the selection section may newly select an image which matches the concept of the concept term, the collection section may re-collect a related term associated with the image which matches the concept of the concept term, and the calculation section may recalculate a term feature amount of a term group of the related term re-collected by the collection section.

Further, the selection section may newly select an image which matches the concept of the concept term in accordance with operation of a user.

The information processing apparatus may further include a creation section for creating an image recognizer capable of recognizing a predetermined image feature amount from an image group which matches the concept of the concept term and which is selected by the selection section. Further, the selection section may newly select an image which matches the concept of the concept term in accordance with an image recognition degree obtained from the image recognizer created by the creation section.

Further, when a mapping on the concept map of the concept term depending on the term feature amount recorded in the recording section is changed in accordance with operation of a user, the calculation section may recalculate a term feature amount of the concept term based on the updated mapping position of the concept term on the concept map.

Further, the selection section may select an image which matches the concept of the concept term from the plurality of images extracted from the extraction section in accordance with an image recognition degree obtained from the image recognizer created by the creation section.

According to another embodiment of the present invention, there is provided an information processing method which includes the steps of inputting a concept term indicating a predetermined concept, extracting, when the input concept term corresponds to a related term associated with a plurality of images, the plurality of images each associated with the related term, selecting an image which matches the concept of the concept term from the extracted plurality of images, collecting a related term associated with the selected image which matches the concept of the concept term, and calculating a term feature amount of a term group of the collected related term.

According to another embodiment of the present invention, there is provided a program for causing a computer to function as an information processing apparatus, in which a plurality of images are associated with a plurality of related terms related to each of the plurality of images, which includes an input section for inputting a concept term indicating a predetermined concept, an extraction section for extracting, when the concept term input by the input section corresponds to the related term, the plurality of images each associated with the related term, a selection section for selecting an image which matches the concept of the concept term from the plurality of images extracted by the extraction section, a collection section for collecting a related term associated with the image which matches the concept of the concept term and which is selected by the selection section, and a calculation section for calculating a term feature amount of a term group of the related term collected by the collection section.

According to the embodiments of the present invention described above, the user profile can be created based on the image group classified with respect to each concept that the user imagines.

### BRIEF DESCRIPTION OF THE DRAWINGS

FIG. 1 is an explanatory view illustrating an outline of profile creation according to an embodiment of the present invention;

FIG. 2 is an explanatory view showing an example of a hardware configuration of an information processing apparatus according to the embodiment;

FIG. 3 is a block diagram showing a functional configuration of the information processing apparatus according to the embodiment;

FIG. 4 is an explanatory view illustrating contents of a term-and-image database according to the embodiment;

FIG. 5 is an explanatory view illustrating contents of concept information stored in a concept information database according to the embodiment;

FIG. 6 is an explanatory view illustrating a degree of association between concept terms shown on a concept map according to the embodiment;

FIG. 7 is a flowchart showing a detail of profile creation processing according to the embodiment;

FIG. 8 is an explanatory view illustrating feedback processing using an SVM according to the embodiment;

FIG. 9 is an explanatory view illustrating a usage of TF-IDF according to the embodiment;

FIG. 10 is an explanatory view illustrating an example of updating a profile according to the embodiment;

FIG. 11 is an explanatory view illustrating an example of updating the profile according to the embodiment;

FIG. 12 is an explanatory view illustrating an example of an application of the profile according to the embodiment; and

FIG. 13 is an explanatory view illustrating an example of an application of the profile according to the embodiment.

### DETAILED DESCRIPTION OF THE EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

[1] Object of present embodiment
[2] Hardware configuration of information processing apparatus
[3] Functional configuration of information processing apparatus
[4] Detail of profile creation processing in information processing apparatus
[5] Example of updating profile
[6] Example of application of profile

### [1] Object of Present Embodiment

In recent years, a profile of each user has been created based on a search history or a purchase history of the user, and there has been performed a search of a commercial product or a recommendation of content utilizing the profile. It is expected that the enhancement in those recommendation technology utilizing the profile and usability using the profile will continue to scale up. Further, the profiles are not dependent on a specific site or purpose, but are shared under various circumstances, such as utilization thereof in other sites and consumer electronics devices.

Nowadays, in creating the profile, there are used an attribute of the user which is prepared beforehand based on the kind and the manufacturer of the commercial product that the user purchases, a keyword input by the user, and the like. For example, the keyword input by the user and the attribute of the user prepared beforehand are matched with each other, and a commercial product or content related to the input keyword is recommended.

However, in the method described above, there are many cases where the keyword input by the user and a keyword or the attribute prepared beforehand are not matched with each other. That is, even when the user inputs a keyword while having some kind of concept in his/her mind, there are some cases where very few of those having the concept exist or some cases where those having different concept from the user's concept are obtained. Further, when the user had difficulties in verbalizing the concept which the user imagines, there was an issue that the creation itself of a query to be a search key was difficult to perform. Further, there are assumed various scenes that the concept which the user imagines do not match well, including: dealings with homonyms, partially matched keywords, and completely new words such as names of people and trade names; and a distance measurement between terms.

Consequently, there is disclosed a technology for creating a profile of each user based on a search query term and a search history using the search query term and providing a search result desired by the user. However, in the technology, it is possible to extract preference with respect to a specific object name or proper noun, but there is a possibility that information that is far from the concept of the user is provided in the case of emotional expression including adjective, the interpretation of which differs between individuals.

The above issues pose a great impediment to a usage or update of the profile. In particular, in the case of automatically updating the profile, new information is collected by using a term while a degree of correspondence between a concept of the user and the term remains to be vague. In this case, in order to obtain information desired by the user, it has been necessary to correct the once generated profile. Consequently, an information processing apparatus 10 according to the embodiment of the present invention is produced by taking the above circumstances into consideration. According to the information processing apparatus 10 of the present embodiment, the user profile can be created based on the image group classified with respect to each concept that the user imagines.

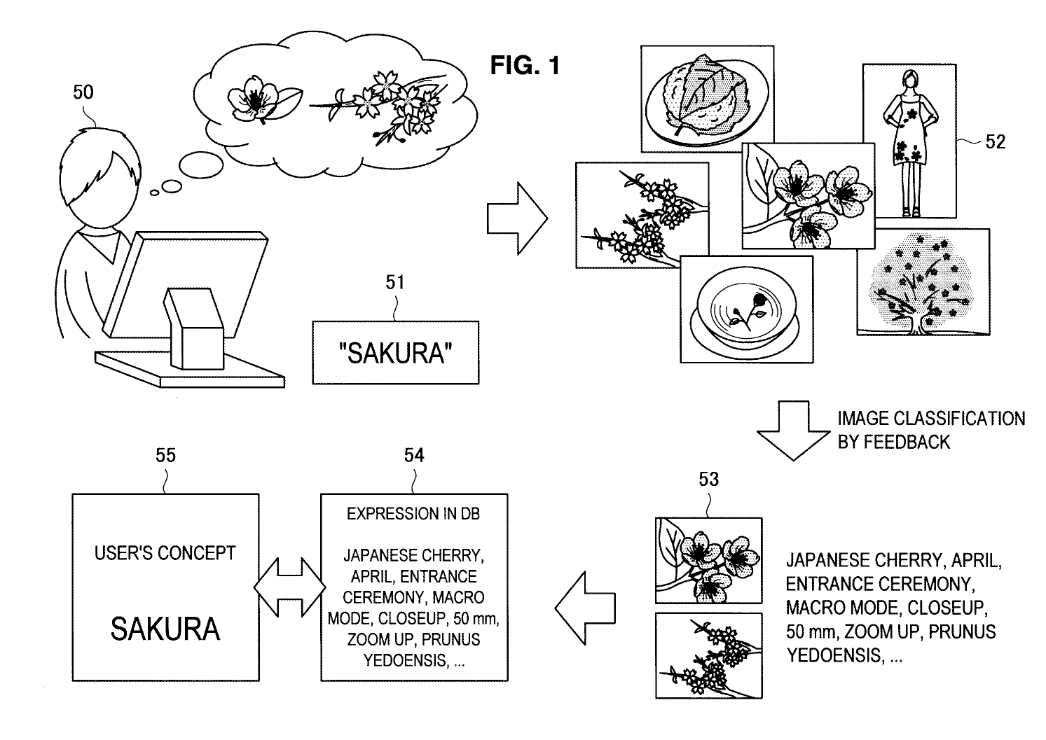

Next, with reference to FIG. 1, an outline of profile creation in the information processing apparatus 10 according to the present embodiment will be described. For example, there is considered the case where a user 50 enters “sakura” (Japanese cherry) as a query term (keyword) 51 from a computer device such as a personal computer. Then, in the information processing apparatus 10, images each corresponding to a related term which includes the term “sakura” are collected. The related term refers to a term associated with the image or to a term set to the image by a user. As the images each corresponding to the related term which includes the term “sakura”, there can be considered, for example, images of “sakura mochi” (pink rice cake which contains sweet bean paste and is wrapped by a salt-preserved cherry-tree leaf), “sakura print dress”, “sakura tree” (cherry tree), “sakura tea”.

For example, even when the user enters “sakura” as a query term while imagining a “sakura tree”, collected images each related to “sakura” include those which are other than the “sakura tree” which is the concept of the user. Consequently, the user classifies the collected images in a manner that the collected images correspond to the concept of the user. That is, the user selects the image including “sakura tree” from the images each corresponding to the related term which includes the term “sakura”. Thus, when the concept of the user is once expressed as an image and the image is selected in accordance with operation of the user, the concept of the user, which has been ambiguous when considered only from the query term, can be clarified.

In addition, the information processing apparatus 10 collects text information 54 associated with the image selected by the operation of the user and associates the text information 54 with the entered query term “sakura”. In this way, text information which matches the concept of “sakura” that the user 50 imagines is associated with the query term “sakura”. For example, even when a term which links the concept that the user imagines to the image and a term which links a concept that a content creator imagines to the image do not correspond to each other, the concept and the terms of the both can be linked to each other through the image.

Still further, the information processing apparatus 10 is capable of calculating a term feature amount of the collected text information 54 and more accurately expressing the concept of the user based on the feature amount. The term feature amount is calculated in consideration of an appearance frequency of a term group associated with an image group that does not match the concept of the user and is not selected by the operation of the user, or an appearance frequency a specific term included in the collected text information 54. In this way, with respect to a term (concept term) indicating a predetermined concept, there are added to the profile of the user, as new concept information, an image group that matches the concept term, a term group that is linked to the image, and a term feature amount that is calculated based on the term group. In the above, the outline of the information processing apparatus 10 has been described.

### [2] Hardware Configuration of Information Processing Apparatus

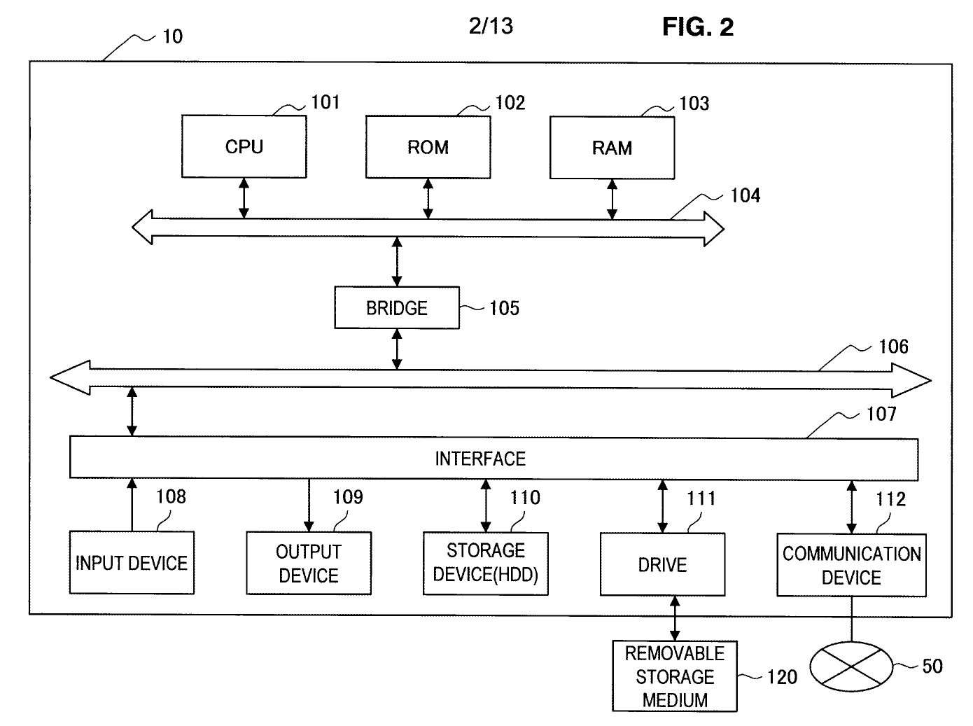

Next, with reference to FIG. 2, a hardware configuration of the information processing apparatus 10 will be described. FIG. 2 is an explanatory view showing an example of the hardware configuration of the information processing apparatus 10 according to the present embodiment.

The information processing apparatus 10 includes a CPU (Central Processing Unit) 101, an ROM (Read Only Memory) 102, an RAM (Random Access Memory) 103, a host bus 104, a bridge 105, an external bus 106, an interface 107; an input device 108, an output device 109, a storage device (HDD) 110, a drive 111, and a communication device 112.

The CPU 101 functions as an arithmetic processing unit and a control unit, and controls an entire operation of the information processing apparatus 10 in accordance with various kinds of programs. Further, the CPU 101 may be a microprocessor. The ROM 102 stores a program, a calculation parameter, and the like which the CPU 101 uses. The RAM 103 primarily stores a program which is used in the execution of the CPU 101, a parameter which appropriately changes due to the execution, and the like. They are connected to each other via the host bus 104 which includes a CPU bus and the like.

The host bus 104 is connected to the external bus 106 such as a PCI (Peripheral Component Interconnect/Interface) bus via the bridge 105. Note that the host bus 104, the bridge 105, and the external bus 106 are not necessarily provided separately from each other, and the functions thereof may be implemented on one bus.

The input device 108 includes, for example, an input means for a user to input information, such as a mouse, a keyboard, a touch panel, a button, a microphone, a switch, and a lever, and an input control circuit which generates an input signal based on an input from the user and outputs the input signal to the CPU 101. The user of the information processing apparatus 10 can input various kinds of data and can instruct a processing operation to the information processing apparatus 10 by operating the input device 108.

The output device 109 includes, for example, a display device such as a CRT (Cathode Ray Tube) display device, a liquid crystal display (LCD) device, an OLED (Organic Light Emitting Display) device, and a lamp, and an audio output device such as a speaker and headphones. The output device 109 outputs, for example, reproduced content. Specifically, the display device displays various kinds of information such as reproduced video data in a form of text or image. On the other hand, the audio output device converts reproduced audio data or the like into sound and outputs the sound.

The storage device 110 is a device for storing data, which is configured as an example of a storage section of the information processing apparatus 10 of the present embodiment. The storage device 110 can include, for example, a storage medium, a recording device for recording data in the storage medium, a reading device for reading out the data from the storage medium, and a deletion device for deleting the data recorded in the storage medium. The storage device 110 is configured to include, for example, an HDD (Hard Disk Drive). The storage device 110 drives a hard disk and stores a program and various kinds of data executed by the CPU 101.

The drive 111 is a reader/writer for the storage medium and is built in or externally attached to the information processing apparatus 10. The drive 111 reads out information recorded in a removable storage medium 120 which is mounted thereto, such as a magnetic disk, an optical disk, a magneto-optical disk, or a semiconductor memory, and outputs the information to the RAM 103.

The communication device 112 refers to, for example, a communication interface which is configured to include a communication device for establishing a connection with a communication network 50. Further, the communication device 112 may be a wireless LAN (Local Area Network) enabled communication device, a wireless USB enabled communication device, or a wired communication device for performing wired communication.

### [3] Functional Configuration of Information Processing Apparatus

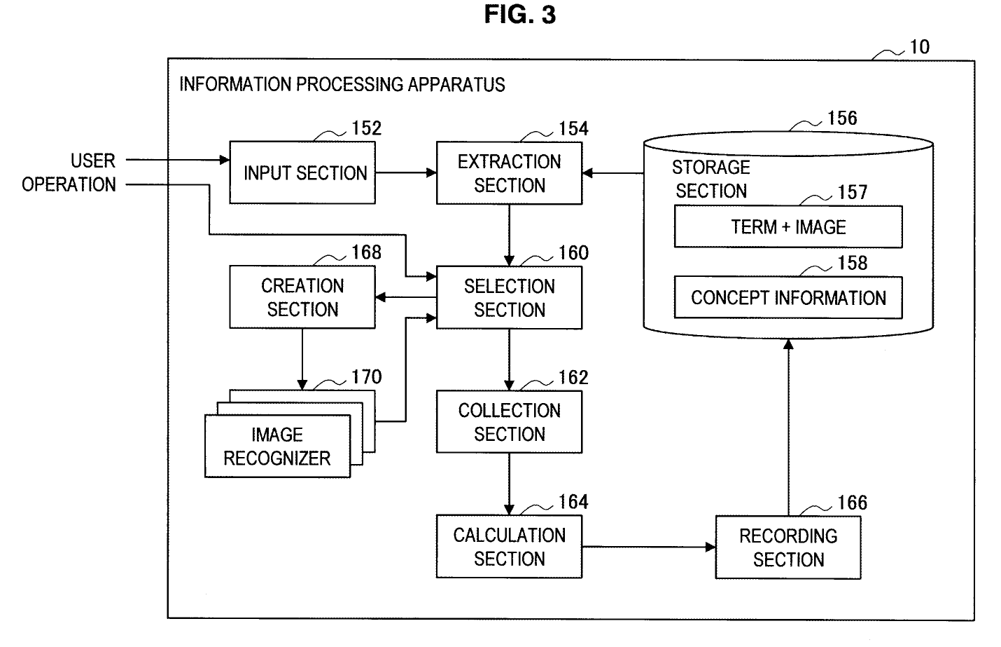

In the above, the hardware configuration of the information processing apparatus 10 has been described. Next, with reference to FIG. 3, a functional configuration of the information processing apparatus 10 will be described. As shown in FIG. 3, the information processing apparatus 10 includes an input section 152, an extraction section 154, a storage section 156, a selection section 160, a collection section 162, a calculation section 164, a recording section 166, a creation section 168, an image recognizer 170, and the like.

The input section 152 has a function of inputting a concept term indicating a predetermined concept in accordance with operation of the user. Here, the concept means an intention or an image that the user personally has, an information group that expresses the intention or the image. In the present embodiment, such a term indicating the concept that the user imagines is referred to as concept term. The concept term includes, for example, text information such as “sakura” and “clock”. The user enters characters of the concept term indicating the concept that the user imagines, such as “sakura” or “clock”, via the above-mentioned input device 108.

In the case where the concept term input by the input section 152 and a related term related to an image stored in the storage section 156, which is to be described later, correspond to each other, the extraction section 154 has a function of extracting a plurality of images each associated with the related term from the storage section 156. The plurality of images and a plurality of related terms each related to the image are associated with each other, and are stored in the storage section 156 as a term-and-image database 157. In the present embodiment, the storage section 156 is provided in the information processing apparatus 10, but the present embodiment is not limited thereto, and the storage section 156 may be also provided in a separate device from the information processing apparatus 10, and the information processing apparatus 10 may obtain information stored in the storage section 156 via a network.

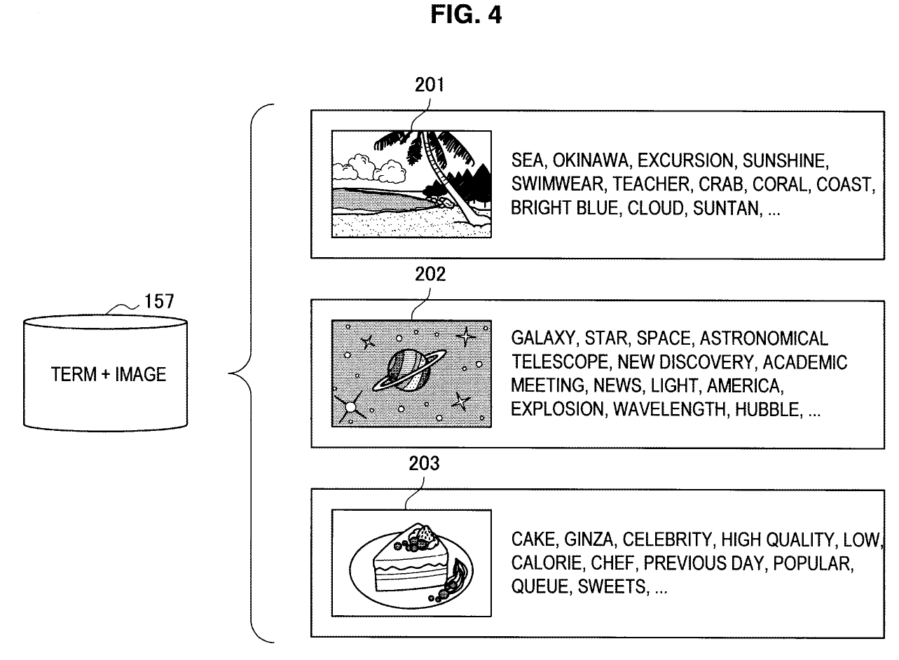

Here, with reference to FIG. 4, contents of the term-and-image database 157 will be described. FIG. 4 is an explanatory view illustrating the contents of the term-and-image database 157. For example, as shown in FIG. 4, linked to an image 201 including sea and sand beach are a plurality of related terms which are related to the image 201, such as “sea”, “Okinawa”, “excursion”, “sunshine”, and “swimwear”. Further, for example, linked to an image 202 including a celestial object are related terms such as “galaxy”, “star”, and “space”, and linked to an image 203 including a cake are “cake”, “Ginza”, and “celebrity”. The images and the related terms stored in the term-and-image database 157 may be set or added by a content recommender, or by the user.

As described above, the extraction section 154 searches, from the plurality of related terms stored in the term-and-image database 157, a term corresponding to the concept term input by the input section 152. Then, an image group which is associated with the related term corresponding to the concept term is extracted. For example, in the case where “sakura” is entered as a concept term, images each corresponding to the related term which includes “sakura” are extracted. As the images each corresponding to the related term which includes “sakura”, there can be considered not only an image of “sakura tree”, but also images of “sakura mochi”, “sakura print dress”, “sakura tea”, and the like. The extraction section 154 provides the plurality of images extracted from the storage section 156 to the selection section 160.

The selection section 160 has a function of selecting an image which matches the concept of the concept term from the plurality of images provided from the extraction section 154. The image which matches the concept of the concept term refers to the image which matches the concept that the user who enters the concept term imagines. For example, in the case where the user enters “sakura” as a concept term, and although the user imagines “sakura tree”, images other than “sakura tree” are included in the images each corresponding to the related term, such as “sakura mochi” and “sakura print dress”. In this case, the image which matches the concept of the concept term refers not to an image of “sakura mochi” or “sakura print dress”, but to an image of “sakura tree”.

Further, the selection section 160 may select the image which matches the concept of the concept term from the plurality of images extracted by the extraction section 154 in accordance with the operation of the user. For example, the plurality of images extracted by the extraction section 154 may be displayed on a display screen of a display device (not shown), and the user may select the image which matches the concept of the concept term from the plurality of images via an input device. The selection of the image by the operation of the user may be performed by classifying the plurality of images into the images which match the concept of the concept term and the images which do not match the concept of the concept term.

Further, the selection of the image by the operation of the user may also be performed by deleting the images which do not match the concept of the concept term from the display screen. Further, the image may be selected step by step by the operation of the user. For example, several images are selected by the operation of the user, and then appropriate images may be selected therefrom based on an image feature amount of the images. After that, the selected images are shown to the user, and an appropriate image may be again selected therefrom by the operation of the user. In this manner, feedback on whether or not the concept corresponds to the images may be performed a plurality of times.

For example, the user may enter the concept term “sakura” while imagining the image of only “sakura tree”. In this case, on the stage in which images are selected for the first time, the images including “sakura tree” and the images including objects other than the sakura tree, such as a building, are selected, but after the feedback is performed for a plurality of times, the images of only “sakura tree” are selected. The feedback function described above can be realized by an interaction between the apparatus and a technology including machine learning such as SVM (Support vector machine) and Boosting. A detail of the feedback function will be described later.

When the feedback on whether or not the images correspond to the concept which the user imagines is performed by the operation of the user, it becomes possible for the selection section 160 to select an image which is more appropriate for the user. For example, it is not possible to figure out that the concept which the user imagines indicates “sakura tree” only from the text information of “sakura”, but by allowing the user to select an image by displaying images related to “sakura”, it becomes possible to figure out more clearly the concept of the image which the user imagines. The selection section 160 provides information of the selected image to the collection section 162. Further, the selection section 160 also provides the information of the selected image to the creation section 168. The creation section 168 has a function of creating an image recognizer 170 capable of recognizing a predetermined image feature amount from an image group which matches the concept of the concept term and which is selected by the selection section 160. One image recognizer 170 is created for each concept term. The image recognizer 170 extracts and learns image feature amount of a plurality of images.

For example, the image recognizer 170 compares an image feature amount extracted from the image group that matches the concept term “sakura” with an image feature amount of the input image, and can determine whether the input image matches the concept term “sakura”. That is, although it has been described above that the input image is selected by the operation of the user, it is also possible to select the input image by using the image recognizer 170 which has learned the plurality of images. However, before selecting the input image, it is necessary that the image recognizer 170 learn beforehand the image group which matches a predetermined concept and which is selected in accordance with the operation of the user.

The collection section 162 has a function of collecting a related term related to the image which matches the concept of the concept term and which is selected by the selection section 160. The collection section 162 may collect text information which is added to the image as metadata, or may collect a term which is linked to the image from the term-and-image database 157. For example, the image which is finally selected is an image of only “sakura tree”, and the terms included in the related terms are not only those which directly link to the concept of “sakura”, but also those which do not directly link thereto, such as “Japanese cherry”, “April”, “entrance ceremony”, “macro mode”, and “closeup”. The collection section 162 provides the collected related term to the calculation section 164.

The calculation section 164 has a function of calculating a term feature amount of a term group of the related term collected by the collection section 162. The calculation section 164 calculates the term feature amount depending on an appearance frequency of the related term collected by the collection section 162. Further, the calculation section 164 may calculate the term feature amount depending on an appearance frequency of a related term associated with an image group of the image that is selected as the one which does not match the concept term by the selection section 160.

The term feature amount refers to a term feature vector which is generated by using the term group collected by the collection section 162 and the appearance frequency thereof. As described above, the term feature vector is calculated in consideration of the appearance frequency of the term group associated with the image group which is removed by feedback, or the appearance frequency of a specific term from all term groups in a database, and hence can more accurately express the concept of the user. As a method of extracting an important term from the term group, there are used a morphological analysis, TF-IDF, and the like. The creation of the term feature amount using those methods will be described in detail later. The calculation section 164 provides the calculated term feature amount to the recording section 166.

The recording section 166 has a function of recording the concept term which is correlated with the term feature amount provided by the calculation section 164 into a storage medium as concept information. In addition, the recording section 166 may record the concept term, which is correlated with the related image group related to the concept term selected by the selection section 160, the related term group collected by the collection section 162, and the term feature amount calculated by the calculation section 164, into the storage medium as concept information. In the present embodiment, a concept information database 158 is recorded with the term-and-image database 157 into the storage section 156, and the present embodiment is not limited thereto, and those databases may be recorded in different storage media.

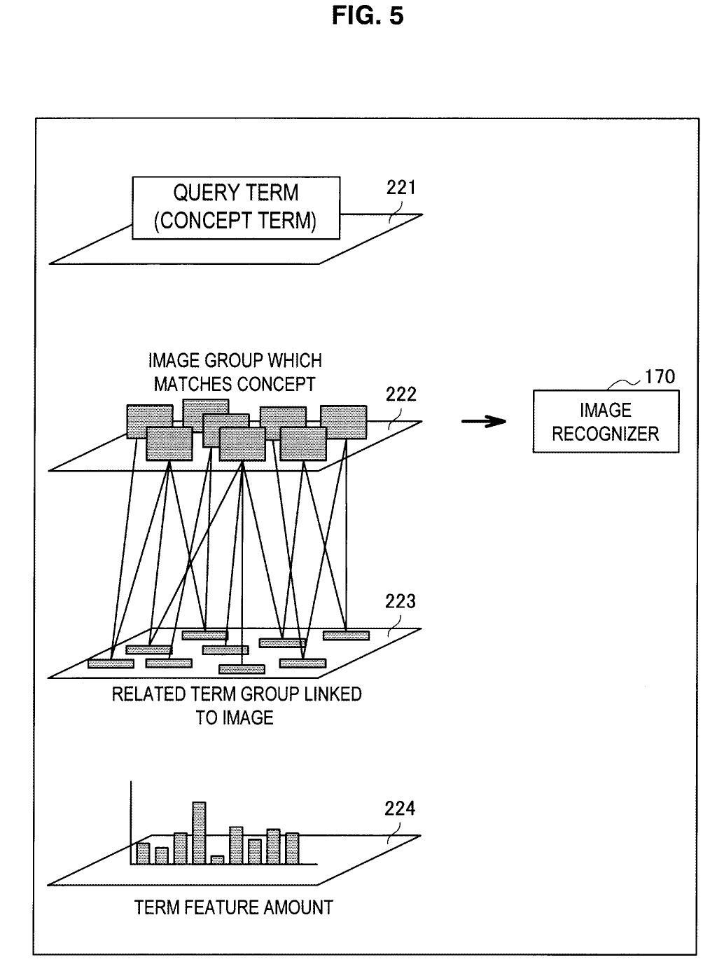

Here, with reference to FIG. 5, the contents of the concept information stored in the concept information database 158 will be described. As shown in FIG. 5, with respect to a query term (concept term) 221 which is input by the operation of the user, an image group 222 which matches the concept, a related term group 223 which is linked to the image group 222, and a term feature amount 224 of the related term group 223 are correlated with each other, and they are stored as one piece of concept information. In addition, the image recognizer 170 which is created from the image group 222 is also correlated therewith and stored. As described above, the image and the related terms related to the image are already correlated with each other in the term-and-image database 157 and stored therein. Therefore, in the concept information database 158, data may be managed by using related information included in the term-and-image database 157.

Further, in the present embodiment, the image recognizer 170 is included in the information processing apparatus 10. However, the image recognizer 170 may also be provided as a separate device from the information processing apparatus 10. In this case, it is necessary to perform, between the information processing apparatus 10 and the separate device, the association between the image recognizer 170 and the concept information. Returning to FIG. 3, the description of the functional configuration of the information processing apparatus 10 is continued.

Further, the recording section 166 may record the concept terms by mapping the concept term on a predetermined concept map depending on the term feature amount calculated by the calculation section 164. In the case of using concept terms input by the user as a profile of the user, it is necessary to figure out the relationship between concept terms. For example, the relationship between concept terms can be clarified by calculating a distance between the concept terms. The distance between the concept terms can be calculated by directly comparing the distance between the concept terms. To directly compare the distance between the concept terms means that a difference in hierarchies is compared based on hierarchical structures of the terms which are shown in a concept dictionary, for example.

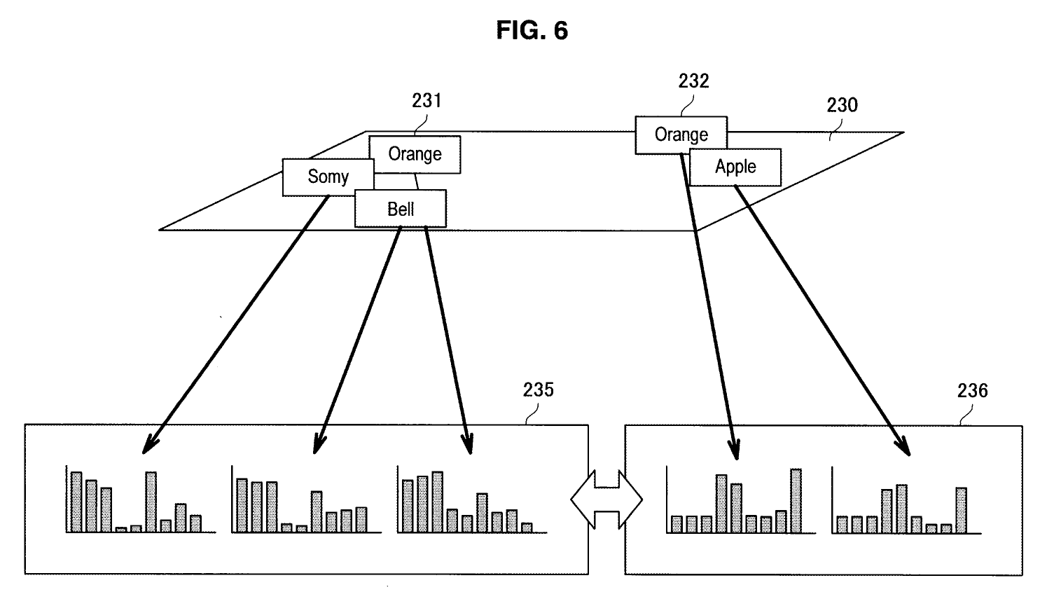

However, the hierarchical structures of the terms shown in a concept dictionary or the like do not reflect a concept of each user, and hence, it is not appropriate to perform the comparison based on such hierarchical structures. Accordingly, in the present embodiment, distance calculation on which the concept of each user is reflected is performed by calculating the distance between the concept terms based on the term feature amount calculated by the calculation section 164. Then, a degree of association between the concept terms is obtained based on the calculated distance between the concept terms, and the degree of association can be mapped on the concept map. Here, with reference to FIG. 6, the degree of association between the concept terms shown on the concept map will be described. FIG. 6 is an explanatory view illustrating the degree of association between concept terms shown on the concept map.

As shown in FIG. 6, for example, “Orange” includes a concept of “orange fruit” and a concept of “Orange Co.”. A term feature amount is calculated with respect to each of the concept terms, and for example, a term feature amount such as a term feature amount 235 is calculated for “Orange” indicating the concept of Orange Co. Further, as for “Orange” indicating the concept of the “orange fruit”, a term feature amount such as a term feature amount 236 is calculated. Although they have the same character string “Orange”, it is considered that the degree of association between the term feature amount 235 and the term feature amount 236 is low and the distance therebetween is large. Therefore, an “Orange” 231 of Orange Co. and an “Orange” 232 of the fruit shown on a concept map 230 are mapped at positions distant from each other. In addition, as a mapping method for concept terms, there may be used a multidimensional scaling method or the like to thereby perform mapping for providing visual information.

Further, in the vicinity of the “Orange” 231 indicating the concept of Orange Co., there are mapped terms each indicating a concept of a company, such as “Somy” for Somy Co., “Bell” for Bell Co., and the like. Further, in the vicinity of the “Orange” 232 indicating the concept of the orange fruit, there is mapped a term indicating a concept of a fruit, such as “Apple”. Thus, even though there are the concept terms having the same character string among the concept terms input by the operation of the user, when the concept term includes two or more different concepts, a term feature amount can be obtained for each of the different concepts. Further, it becomes possible to create those concept terms into a profile of each user as different concepts. In the above, the functional configuration of the information processing apparatus 10 has been described.

### [4] Detail of Profile Creation Processing in Information Processing Apparatus

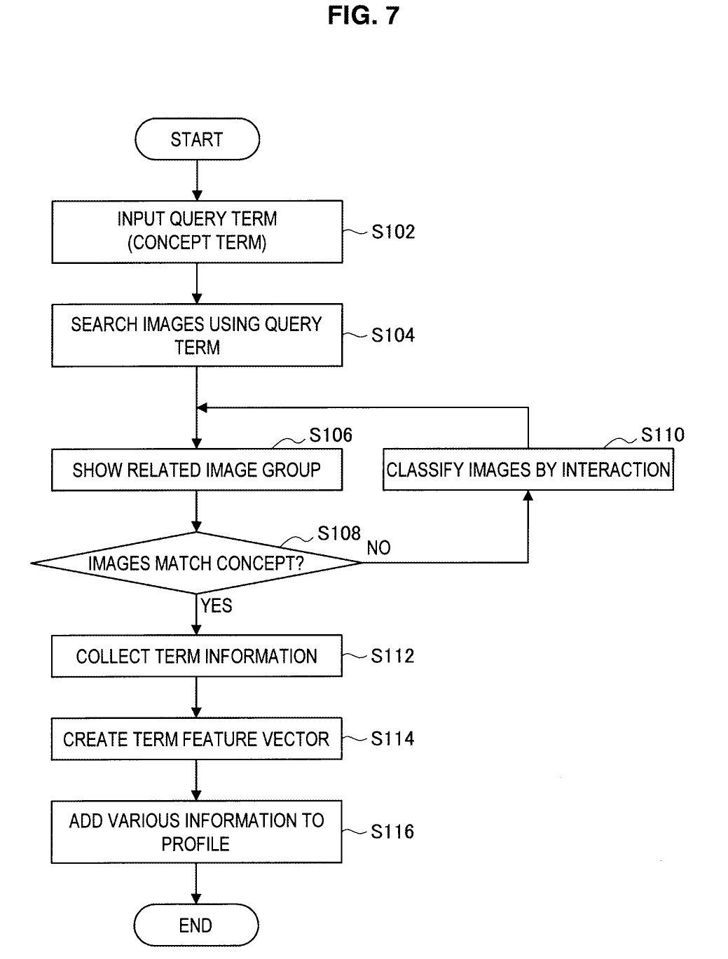

Next, with reference to FIG. 7, a detail of profile creation processing performed in the information processing apparatus 10 will be described. FIG. 7 is a flowchart showing the detail of the profile creation processing performed in the information processing apparatus 10. As shown in FIG. 7, first, in accordance with the operation of the user, a query term (concept term) is input by the input section 152 (S102). In Step S102, the extraction section 154 searches an image group associated with a term (related term) which corresponds to the input query term (S104).

Then, the related image group searched in Step S104 is shown to the user (S106). The related images shown to the user in Step S106 may be all images which are extracted from the extraction section 154, or may be some of those images. Then, it is determined by the user whether the shown image group corresponds to the concept shown by the user. The selection section 160 determines, in accordance with the operation of the user, whether the plurality of images match the concept of the input query term (S108). In Step S108, the selection section 160 searches images appropriate for the user based on the determination result by the user (S110). In Step S110, the plurality of images are classified into the images which match the concept of the concept term and the images which do not match the concept of the concept term.

Then, the result obtained by the search is shown again to the user (S106). In addition, the user selects an image which matches more to the concept that the user imagines from the images shown in Step S106. In this manner, learning is performed based on the interaction with the user, and hence, images which are appropriate for the user are searched. The processing of Step S106 to Step S110 is repeated until appropriate images are obtained in Step S108. The feedback processing of Step S106 to Step S110 enables the selection of appropriate images.

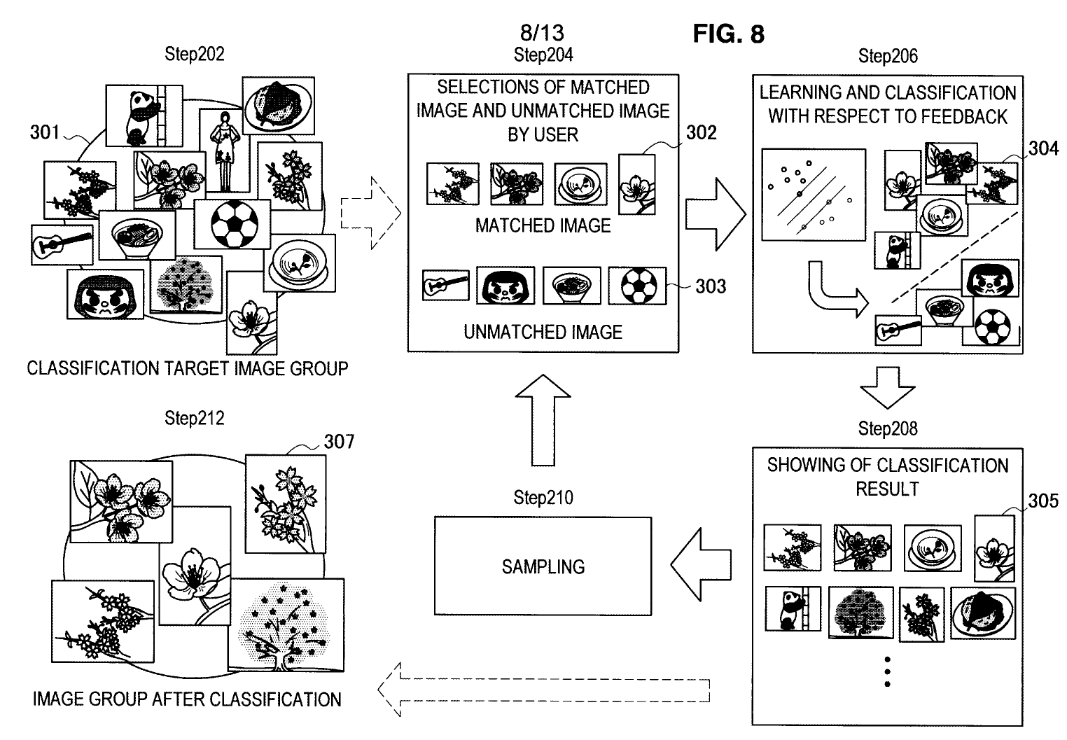

Here, with reference to FIG. 8, feedback processing using an SVM will be described in detail. FIG. 8 is an explanatory view illustrating the feedback processing using the SVM. First, an outline of the SVM will be described. The SVM is an algorithm for creating an identification interface in data space by using several positive samples and negative samples, and the interface is formed of a sample group referred to as support vector. Training data include N input vectors x₁, . . . , x_{N} and labels t₁, . . . , t_{N} corresponding thereto, N representing the number of pieces of data, and it is assumed that an unknown data point x is classified by the following symbols.

[Equation 1]

y(x)=w^{T}φ(x)+b (1.1)

In this case, a weight vector w and a bias parameter b are obtained by optimizing the following formula from the basis of margin maximization.

$$\begin{matrix}[ Equation 2 ] & \\ {arg max}_{w , b} \{ \frac{1}{‖ w ‖} {min}_{n} [ {t}_{n} ( {w}^{T} ϕ ( {x}_{n} ) + b ) ] \} & ( 1.2 )\end{matrix}$$

The margin refers to a shortest distance from an identification surface to the support vector, and by maximizing the margin, high generalization capability can be obtained.

Formula (1.2) may be rewritten as the following maximization with respect to an object function a by introducing a Lagrange multiplier and KKT conditions:

$$\begin{matrix}[ Equation 3 ] & \\ \tilde{L} ( a ) = {\sum }_{n = 1}^{N} {a}_{n} - \frac{1}{2} {\sum }_{n = 1}^{N} {\sum }_{m = 1}^{N} {a}_{n} {a}_{m} {t}_{n} {t}_{m} k ( {x}_{n} , {x}_{m} ) & ( 1.3 )\end{matrix}$$

provided that α satisfies the following constraint conditions.

$${a}_{n} \geq 0 , n = 1 , … , N \\ {\sum }_{n = 1}^{N} {a}_{n} {t}_{n} = 0 \qquad ( 1.4 )$$

When Formula (1.1) is rewritten based on those formulae, it is represented as follows.

$$\begin{matrix}[ Equation 4 ] & \\ y ( x ) = {\sum }_{n = 1}^{N} {a}_{n} {t}_{n} k ( x , {x}_{n} ) + b & ( 1.5 )\end{matrix}$$

The solution to the optimization problem of Formula (1.3) can be obtained by solving the quadratic programming problem, and when the value for α is solved, the value for the bias parameter b can be also solved.

Adaptive feedback is a technique in which the user evaluates collected data and the classification thereof is corrected based on the evaluation. The learning and classification in accordance with the adaptive feedback are performed by “Selector” and “Learner”. Selector decides which data is to receive the feedback from the user based on the previous learning and classification, and Learner performs re-learning based on the received feedback.

Here, with reference to FIG. 8, image classification in accordance with the adaptive feedback will be described. FIG. 8 is an explanatory view illustrating the image classification in accordance with the adaptive feedback. The flow of the adaptive feedback in the case where the inputs used for the feedback are limited to two values, “matched” and “unmatched”, is as follows. Hereinafter, there is described feedback processing which is performed after a classification target image group 301 is shown to the user (Step 202) and the selection between matched images and unmatched images is performed by the user.

Selector performs sampling of images which are to be targets of feedback from a database and show the images to the user (Step 210). Then, the user provides a feedback of either matched (positive) or unmatched (negative) with respect to the shown image (Step 204). After that, Learner adds the feedback received in Step 204 to the training data and performs learning and classification (Step 206). The user performs an evaluation on whether the classification result obtained in Step 206 complies with the concept that the user imagines (Step 208). When the classification result is insufficient, the sampling of Step 210 is performed again to continue the feedback, and newly selected images are shown to the user (Step 204).

The sampling by Selector in Step 210 is performed using a criterion such as Most Ambiguous. Most Ambiguous performs sampling of data which is nearest to the identification interface created by the SVM, and can lessen the ambiguity in the identification. At the time of starting the interaction before the learning is performed, the image group obtained by a term search is shown to the user.

By using the SVM for Learner in the adaptive feedback, an image group which matches the concept of the user can be collected. As an image classifier which is built by the image group, there can be used a classifier of the SVM used at the time of the adaptive feedback as it is, or, because there is no need to consider about the response speed with respect to the user once the interaction is completed, a learning algorithm using Boosting or Bootstrap, which is computationally expensive but is strong.

In the above, the feedback processing using the SVM has been described. Returning to FIG. 7, the description on the profile creation processing performed in the information processing apparatus 10 will be continued. In Step S108, in the case where it is determined that the image matches the concept which the user images, the collection section 162 collects term information associated with the image selected by the feedback processing (S112). The term group collected in Step S112 includes terms that are not shown for the query term input by the user.

It can be considered that the term group that is not shown for the query term input by the user appropriately shows the concept of the user. This indicates that, even when a term which links the concept of the user to the image and a term which links a concept of a content creator to the image do not correspond with each other, it becomes possible, by expressing the concept of the user as an image, to link those concepts and the terms of the both to each other through the image.

Next, the calculation section 164 creates a term feature vector from the term information collected in Step S112 (S114). Here, a method of calculating a term feature amount from the related term group linked to the image will be described. In Step S112 of FIG. 7, the images in the database are classified into the image group that complies with the concept of the user and the image group that does not comply therewith by the already-performed concept matching. Further, the classified image groups each accompany therewith a term group associated with each image. Based on those pieces of information, there can be considered a TF-IDF method as one means for creating the term feature amount.

The TF-IDF method is a technique for performing weighting of a degree of importance of a term which appears in a document. The weighting of the degree of importance can be calculated with a TF (Term Frequency) representing an appearance frequency of a specific term in the document and an IDF (Inverse Document Frequency) representing a paucity of documents including the specific term.

[Equation 5]

tfidf=tf·idf

When an appearance frequency of a term tᵢ included in a document is represented by nᵢ, tfᵢ is represented as follows:

$${tf}_{i} = \frac{{n}_{i}}{{\sum }_{k} {n}_{k}} \qquad [ Equation 6 ]$$

and idfᵢ is represented as follows.

$${idf}_{i} = log \frac{D}{\{ d \vert {t}_{i} ∈ d \}} \qquad [ Equation 7 ]$$

In this case, {d|tᵢεd} represents number of documents each including the term tᵢ, D represents number of all documents, and idf has functions of decreasing the degree of importance of a term which appears in many documents and increasing the degree of importance of a term which only appears in a specific document. Thus, tfidf represents a property of the term which characterizes the document from two aspects: the appearance frequency of the term within the document; and the paucity of documents in which the term appears.

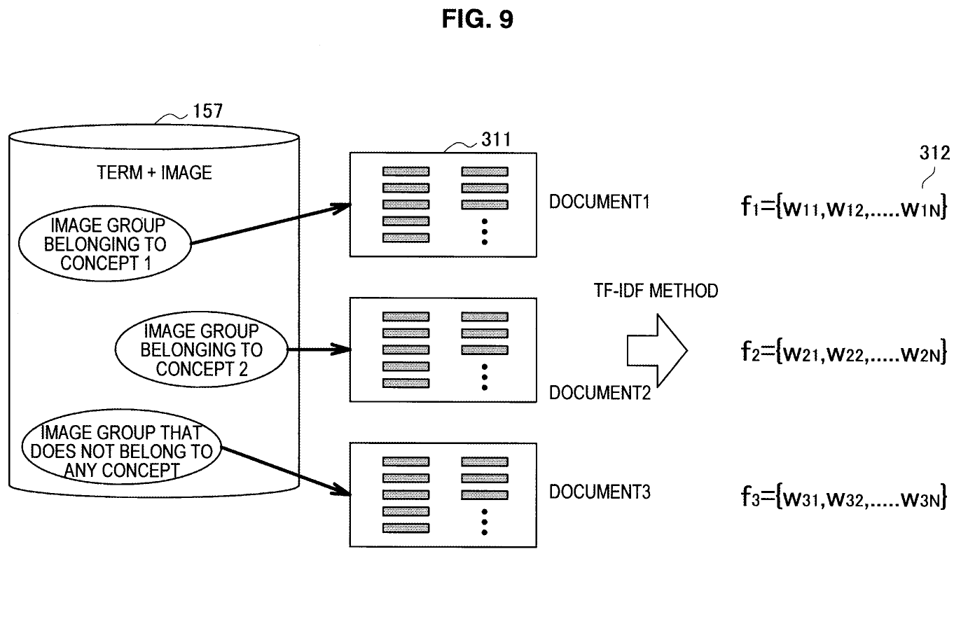

Next, with reference to FIG. 9, a usage of TF-IDF according to the present technique will be described. FIG. 9 is an explanatory view illustrating the usage of TF-IDF. First, image classification as shown in FIG. 9 is performed by the concept matching. That is, images are classified into an image group belonging to Concept 1, an image group belonging to Concept 2, and an image group that does not belong to any concept. At that time, each of those image groups is regarded as one document, and a related term group associated with the image group is regarded as a term included in the document. When the TF-IDF method is used for those sets of documents and terms, the term which characterizes the concept of the user has a large value of tfidf in each document. By saving tfidf values w of all terms obtained from respective documents as vectors, there can be obtained a term feature amount. A distance between feature amounts can be calculated using Euclidean distance or Cosine distance.

In the above, the method of calculating a term feature amount has been described. Returning to FIG. 7, the description of the profile creation processing is continued. After the term feature vector is created in Step S114, the recording section 166 adds the concept information shown in FIG. 5 to the profile of the user (S116). In Step S116, all of the concept information shown in FIG. 5 may be recorded, or only the query term and the term feature amount may be recorded. Further, the degree of association of the concept term shown on the concept map shown in FIG. 6 may be recorded.

In the information processing apparatus 10 according to the present embodiment, in the case where a concept term indicating a predetermined concept is input by the operation of the user and the concept term corresponds to a related term related to a plurality of images stored in the storage section 156, the plurality of images each associated with the related term are extracted from the storage section. Then, in accordance with the operation of the user, the images which match the concept of the concept term are selected from the extracted plurality of images. The related terms associated with the selected images which match the concept of the concept term are collected, and the term feature amount of the term group including the collected related terms is calculated.

This indicates that, even when a term which links the concept of the user to the image and a term which links a concept of a content creator to the image do not correspond with each other, it becomes possible, by expressing the concept of the user as an image, to link those concepts and the terms of the both to each other through the image. That is, when the profile creation is performed by the interaction with the apparatus using the images, it becomes possible to lessen the gap between the term and the concept, which differs from user to user. Further, when the term group imparted to the image is indirectly utilized, it becomes possible to create a term feature amount which matches the concept of the user. Further, it becomes possible to create a concept map that complies with the concept of the user by using the created term feature amount.

### [5] Example of Updating Profile

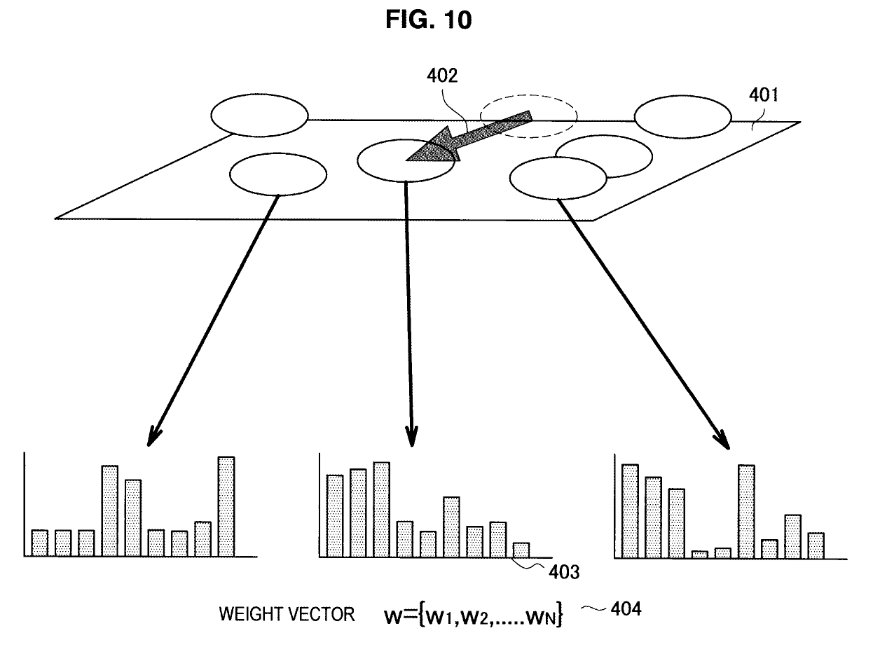

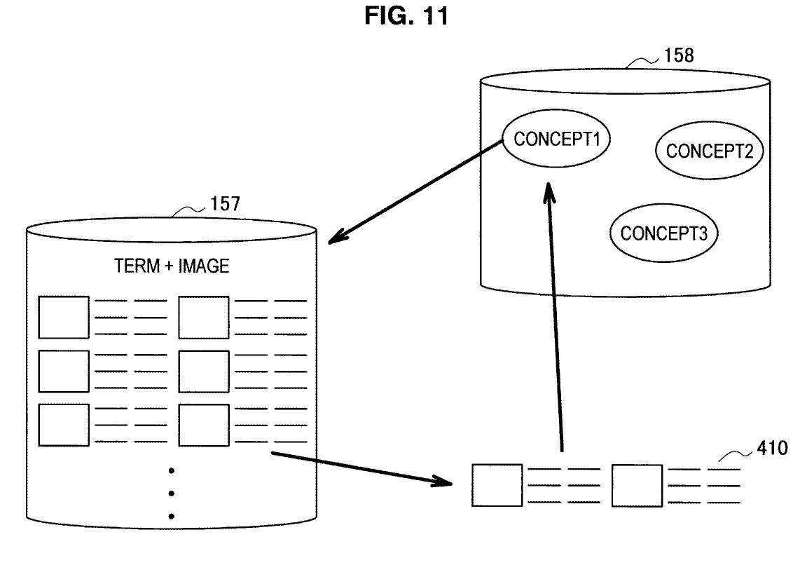

In the above, the detail of the profile creation processing performed in the information processing apparatus 10 has been described. Next, with reference to FIG. 10 and FIG. 11, examples of updating a profile will be described. The update of the profile can be performed by conscious operation of the user or automatic operation of the information processing apparatus 10. First, with reference to FIG. 10, the update of a profile performed by conscious operation of the user will be described.

As one of the ways to update the profile by the conscious operation of the user, there can be exemplified an update of a query term. For example, in the case of updating a query term (concept term) which already exists on the profile, related images are collected based on the interaction with the apparatus through the feedback to the images, which has been shown in the profile creation function. When the related images are collected and updated, a related term group linked to the related image is also updated, and the information subordinate to the concept query is updated. Further, in the case where different concepts are created with respect to the same query term, the profile is updated by newly creating concept information using the same query term.

Further, in the case where a plurality of query terms (concept terms) are created on the profile, it can be also considered that the concept map shown in FIG. 6 is updated. As described above, the concept map is created by the distance calculation based on a term feature vector. At the time of creating the concept map, the dimensional weights in respective feature amounts are equal to each other. Consequently, in the case where the positional relationship of respective concepts is corrected on the concept map in accordance with the operation of the user, update of the map and distance scale can be realized by updating the dimensional weights in respective feature amounts. For example, as shown in FIG. 10, as the method of realizing the update of the weight there can be considered a method involving projecting a concept map two-dimensionally, the user operating (arrow 402) a position of each concept through GUI, and determining a weight using a positional relationship after the operation.

Next, with reference to FIG. 11, the update of the profile performed by the information processing apparatus 10 will be described. In the automatic updating which is performed without input by the operation of the user, it is necessary to be beware that profile information is not updated towards the direction that is not intended by the user. Therefore, a query term, a related term, and the like are not used in the present embodiment, which are the pieces of information in which interpretation, distance between terms, and the like are considerably different from person to person. Hereinafter, the update of a profile using the image recognizer 170 which is created from the images that match the query term will be described.

As shown in FIG. 11, the image recognizer 170 for recognizing each concept recognizes an image in the term-and-image database 157 at an appropriate timing. Then, the image recognizer 170 collects an image-and-related term group 410 which matches the image recognizer 170. As shown in FIG. 5, because the image recognizer 170 is linked to the specific concept, the concept to which the collected data is related is figured out.

Accordingly, the update of a concept information database associated with each query term is performed by adding the newly collected image-and-related term group to the existing image-and-related term group and creating the term feature amount. By employing such an updating method, it becomes possible to adopt a new term without departing from the concept of the user. Note that the automatic update of the profile may be performed at the time of the term-and-image database 157 being updated or at the time which the user specified. It becomes possible to perform the updating which matches the concept of the user by updating the profile using the image recognizer 170.

### [6] Example of Application of Profile

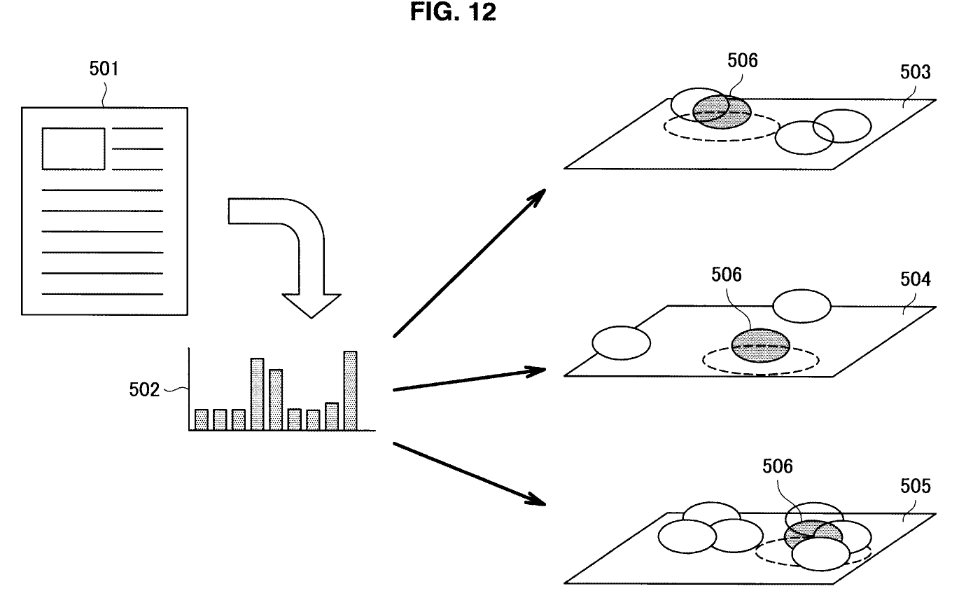

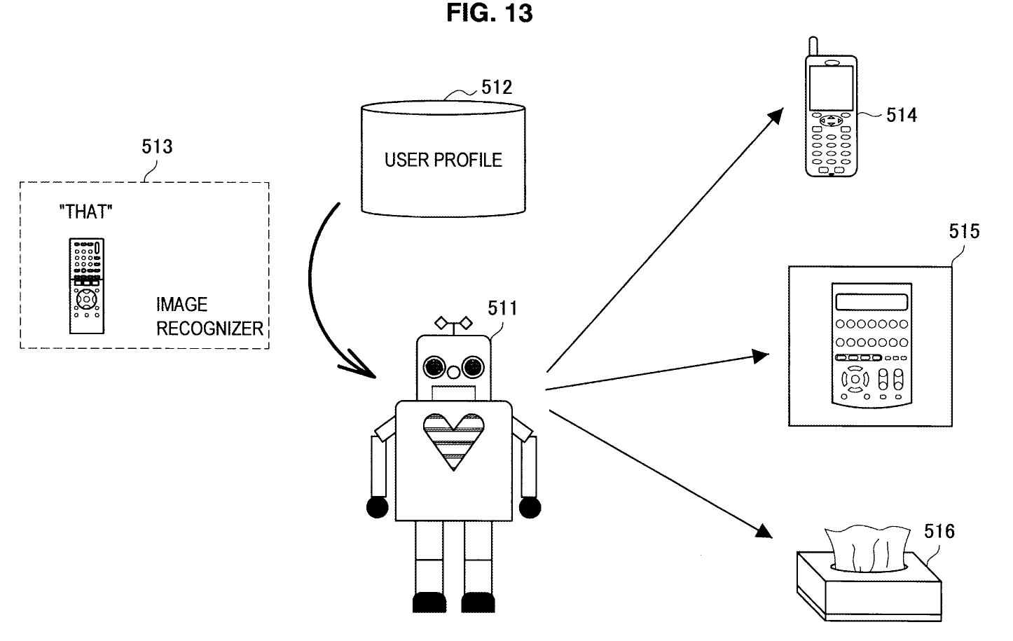

In the above, the examples of updating the profile have been described. Next, with reference to FIG. 12 and FIG. 13, examples of applications of the profile will be described. The utilization of the profile created by the information processing apparatus 10 can be realized by using various kinds of information associated to each concept created on the profile and a concept map showing a distance between concepts. As the services utilizing the profile, there can be considered a search assistant, a recommendation service, a content creation assistant, and the like. Hereinafter, examples of applications of the profile for respective services will be described.

At the time of utilizing the profile as the search assistant, related terms related to a query term entered by the user can be shown, for example. In this way, even in the case where it is difficult for the user to express the term which indicates the concept that the user has in his/her mind, it becomes possible to select the term which matches the concept of the user from the shown related terms. Further, by using two or more terms from the shown related terms, it also becomes possible to narrow down search targets. Further, it is also possible to execute a search based on the term feature amount of the query term entered by the user.

In addition, a recognition result of an image obtained by the search may be utilized via the created image recognizer 170. Further, in the case where the concept information database 158 related to the query term entered by the user is not stored but the query term is registered as a related term of another concept, the another concept and the related term can be shown.

Further, the created profile can be utilized for recommending content or the like. FIG. 12 is an explanatory view illustrating recommendation utilizing the profile. For example, as shown in FIG. 12, first, a term feature amount 502 of a recommendable content 501 is calculated. Next, a position at which the term feature amount 502 appears on the concept map of each user is calculated. For example, on each of a concept map 503 of a user A and a concept map 505 of a user C, there is a concept to be an object of interest in the vicinity of a concept of the recommendable content 506, and hence, the content 501 is recommended to the user A and the user C. Further, on a concept map 503 of a user B, there is no concept to be an object of interest in the vicinity of the concept of the recommendable content 506, and hence, the content 501 is not recommended to the user B. In this manner, it becomes possible to accurately figure out the user to receive recommendation of the content or the like by utilizing the concept maps of respective users.

Further, by utilizing the image recognizer 170 stored in the concept information database 158, content to which the image recognizer shows a reaction may be caused to be an object of recommendation. Further, the profile may be used as an assistant to create content. For example, by investigating related images and related terms of the concept that the user has, it becomes possible to make a study on what content is to be created in order to enhance usability.

Next, with reference to FIG. 13, there will be described utilization of the profile for a physical agent. As shown in FIG. 13, for example, a term “that” is registered as a concept, and, for example, the concept of “that” is registered as “remote control”. In this case, when the user utters a phrase “go and get that”, the physical agent 511 acquires an image recognizer of “that”. Next, the physical agent 511 searches a recognition target placed in the vicinity thereof and recognizes a remote control 515 using the image recognizer, and hence can respond to the instruction of the user. Thus, the created profile can be utilized without being limited to specific applications. Further, it becomes possible to provide various services and information including search and recommendation that comply with the intention of each user.

In the above, the preferred embodiment of the present invention has been described in detail with reference to the appended drawings, but is not limited thereto. It should be understood by those skilled in the art that various modifications, combinations, sub-combinations and alterations may occur depending on design requirements and other factors insofar as they are within the scope of the appended claims or the equivalents thereof.

For example, respective steps included in the processing of the information processing apparatus 10 according to the present specification are not necessarily processed in chronological order in accordance with the flowchart. That is, the respective steps included in the processing of the information processing apparatus 10 may be different processing or may be executed in a parallel manner.

Further, it is also possible to create a computer program for causing hardware such as a CPU, a ROM, and a RAM built in the information processing apparatus 10 to realize a function equivalent to the function of each configuration of the information processing apparatus 10. Further, there is provided a storage medium in which the computer program is stored.

The present application contains subject matter related to that disclosed in Japanese Priority Patent Application JP 2009-161970 filed in the Japan Patent Office on Jul. 8, 2009, the entire content of which is hereby incorporated by reference.

What is claimed is:

1. An information processing apparatus, in which a plurality of images are associated with a plurality of related terms related to each of the plurality of images, comprising:
an input section for inputting a concept term indicating a predetermined concept;
an extraction section for extracting, when the concept term input by the input section corresponds to the related term, the plurality of images each associated with the related term;
a selection section for selecting an image which matches the concept of the concept term from the plurality of images extracted by the extraction section;
a collection section for collecting a related term associated with the image which matches the concept of the concept term and which is selected by the selection section; and
a calculation section for calculating a term feature amount of a term group of the related term collected by the collection section.

2. The information processing apparatus according to claim 1,
wherein the selection section selects an image which matches the concept of the concept term from the plurality of images extracted by the extraction section in accordance with operation of a user.

3. The information processing apparatus according to claim 1,
wherein the calculation section calculates a term feature amount depending on an appearance frequency of the related term collected by the collection section.

4. The information processing apparatus according to claim 3,
wherein the calculation section calculates a term feature amount depending on an appearance frequency of a related term associated with an image group of images that are selected as images which do not match the concept term by the selection section.

5. The information processing apparatus according to claim 1, further comprising
a creation section for creating an image recognizer capable of recognizing a predetermined image feature amount from an image group which matches the concept of the concept term and which is selected by the selection section.

6. The information processing apparatus according to claim 1, further comprising
a recording section for recording the concept term which is correlated with the term feature amount calculated by the calculation section into a storage medium as concept information.

7. The information processing apparatus according to claim 6,
wherein the recording section records the concept term by mapping the concept term on a predetermined concept map depending on the term feature amount.

8. The information processing apparatus according to claim 6,
wherein the recording section records the concept term, which is correlated with the related image group which includes the image selected by the selection section, the related term group which includes the related term and which is collected by the collection section, and the term feature amount which is calculated by the calculation section, into the storage medium as concept information.

9. The information processing apparatus according to claim 1, when, in addition to the plurality of images, other plurality of images are newly associated with a plurality of related terms related to each of the other plurality of images,
wherein the extraction section extracts the plurality of images each associated with the related term corresponding to the concept term,
wherein the selection section newly selects an image which matches the concept of the concept term,
wherein the collection section re-collects a related term associated with the image which matches the concept of the concept term, and
wherein the calculation section recalculates a term feature amount of a term group of the related term re-collected by the collection section.

10. The information processing apparatus according to claim 9,
wherein the selection section newly selects an image which matches the concept of the concept term in accordance with operation of a user.

11. The information processing apparatus according to claim 9, further comprising
a creation section for creating an image recognizer capable of recognizing a predetermined image feature amount from an image group which matches the concept of the concept term and which is selected by the selection section,
wherein the selection section newly selects an image which matches the concept of the concept term in accordance with an image recognition degree obtained from the image recognizer created by the creation section.

12. The information processing apparatus according to claim 7,
wherein, when a mapping on the concept map of the concept term depending on the term feature amount recorded in the recording section is changed in accordance with operation of a user,
the calculation section recalculates a term feature amount of the concept term based on the updated mapping position of the concept term on the concept map.

13. The information processing apparatus according to claim 5,
wherein the selection section selects an image which matches the concept of the concept term from the plurality of images extracted from the extraction section in accordance with an image recognition degree obtained from the image recognizer created by the creation section.

14. An information processing method, comprising the steps of:
inputting a concept term indicating a predetermined concept;
extracting, when the input concept term corresponds to a related term associated with a plurality of images, the plurality of images each associated with the related term;
selecting an image which matches the concept of the concept term from the extracted plurality of images;
collecting a related term associated with the selected image which matches the concept of the concept term; and
calculating a term feature amount of a term group of the collected related term.

15. A program for causing a computer to function as an information processing apparatus, in which a plurality of images are associated with a plurality of related terms related to each of the plurality of images, which includes
an input section for inputting a concept term indicating a predetermined concept,
an extraction section for extracting, when the concept term input by the input section corresponds to the related term, the plurality of images each associated with the related term,
a selection section for selecting an image which matches the concept of the concept term from the plurality of images extracted by the extraction section,
a collection section for collecting a related term associated with the image which matches the concept of the concept term and which is selected by the selection section, and
a calculation section for calculating a term feature amount of a term group of the related term collected by the collection section.
